(19) United States
(12) Patent Application Publication
(10) Pub. No.: US 2014/0166898 A1
(43) Pub. Date: Jun. 19, 2014

(54) ULTRAVIOLET IRRADIATION APPARATUS

(71) Applicant: KABUSHIKI KAISHA TOSHIBA, Tokyo (JP)

(72) Inventors: Norimitsu Abe, Kanagawa-ken (JP); Takeshi Ide, Tokyo (JP); Shinji Kobayashi, Kanagawa-ken (JP); Koji Fujita, Saitama-ken (JP); Akihiko Shirota, Tokyo (JP); Kenji Takeuchi, Tokyo (JP)

(73) Assignee: KABUSHIKI KAISHA TOSHIBA, Tokyo (JP)

(21) Appl. No.: 14/061,382

(22) Filed: Oct. 23, 2013

Related U.S. Application Data
(63) Continuation of application No. 13/563,462, filed on Jul. 31, 2012, now abandoned.

(30) Foreign Application Priority Data
Sep. 14, 2011 (JP) 2011-200836

(51) Int. Cl. C02F 1/32

(52) U.S. Cl. CPC C02F 1/325
USPC 250/436

(57) ABSTRACT

According to the embodiments, an ultraviolet irradiation apparatus includes: a cylindrical water passage body through which treatment target water passes, and which has paired openings in its respective two end portions; at least one ultraviolet irradiation member provided inside the water passage body on a plane orthogonal to a direction from one to the other of the openings, and configured to emit ultraviolet rays to the treatment target water passing through the water passage body; and paired flange joints projecting from peripheral edges of the paired openings of the water passage body outward of the openings, respectively.

### CROSS-REFERENCE TO RELATED APPLICATION(S)

This application is a continuation of U.S. patent application Ser. No. 13/563,462, filed on Jul. 31, 2012 which is based upon and claims the benefit of priority from the prior Japanese Patent Application No. 2011-200836, filed on Sep. 14, 2011, the entire contents of each of which are incorporated herein by reference.

### FIELD

Embodiments of the invention relate to an ultraviolet irradiation apparatus.

### BACKGROUND

Ultraviolet rays are used to sterilize, disinfect and decolorize tap water and sewage, to deodorize and decolorize industrial water, to bleach wood pulp, and to do similar things.

U.S. Pat. No. 7,385,204 discloses ultraviolet irradiation apparatus. In this ultraviolet irradiation apparatus, lamp housings each formed from a circular pipe are each joined to a cylindrical water passage body while crossing the cylindrical water passage. In addition, a plurality of ultraviolet irradiation tubes is installed in the lamp housing. Each ultraviolet irradiation tube includes an ultraviolet lamp, and a quartz glass tube in which the ultraviolet lamp is contained.

Since a predetermined number of ultraviolet irradiation tubes are installed in this ultraviolet irradiation apparatus, the amount of ultraviolet irradiation cannot be adjusted.

### BRIEF DESCRIPTION OF THE DRAWINGS

FIG. 1 is a block diagram of an ultraviolet irradiation apparatus of a first embodiment;

FIG. 2 is a cross-sectional view taken along the A-A line of FIG. 1;

FIG. 3 is a block diagram of an ultraviolet irradiation tube;

FIGS. 4A and 4B are explanatory diagrams of the dimensions of an ultraviolet lamp;

FIG. 5 is a table showing dimensions of pipes specified under the JIS (Japanese Industrial Standards) and their flow rates at a flow speed of 3.0 m/sec;

FIG. 6 is a block diagram of an ultraviolet irradiation apparatus of a second embodiment;

FIG. 7 is a cross-sectional view taken along the B-B line of FIG. 6;

FIG. 8 is a block diagram of an ultraviolet irradiation apparatus of a third embodiment;

FIG. 9 is a block diagram showing an example of an apparatus connecting pipe; and

FIG. 10 is a block diagram showing an example of an apparatus connecting joint.

### DETAILED DESCRIPTION

According to the embodiments, an ultraviolet irradiation apparatus includes: a cylindrical water passage body through which treatment target water passes, and which has paired openings in its respective two end portions; at least one ultraviolet irradiation member provided inside the water passage body on a plane orthogonal to a direction from one to the other of the openings, and configured to emit ultraviolet rays to the treatment target water passing through the water passage body; and paired flange joints projecting from peripheral edges of the paired openings of the water passage body outward of the openings, respectively.

### First Embodiment

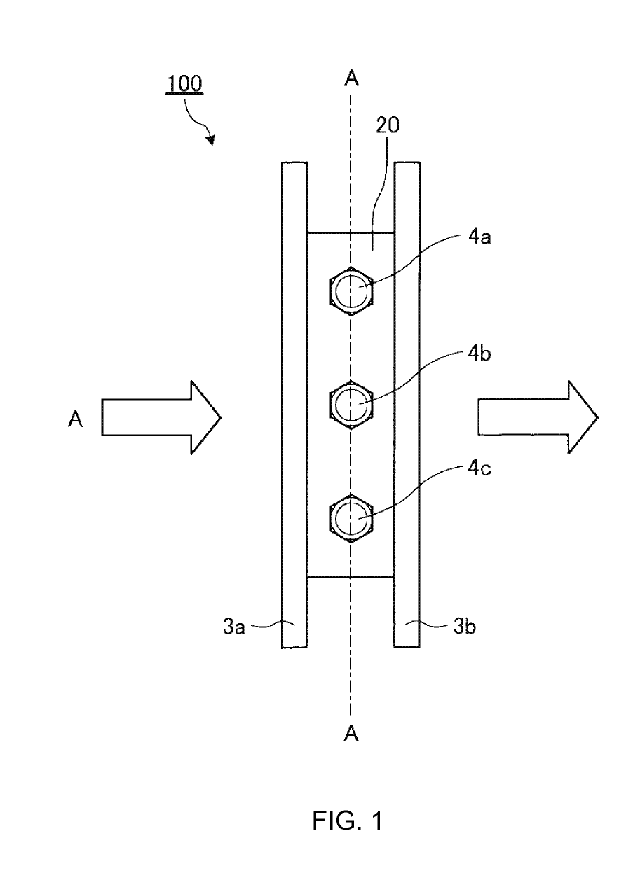

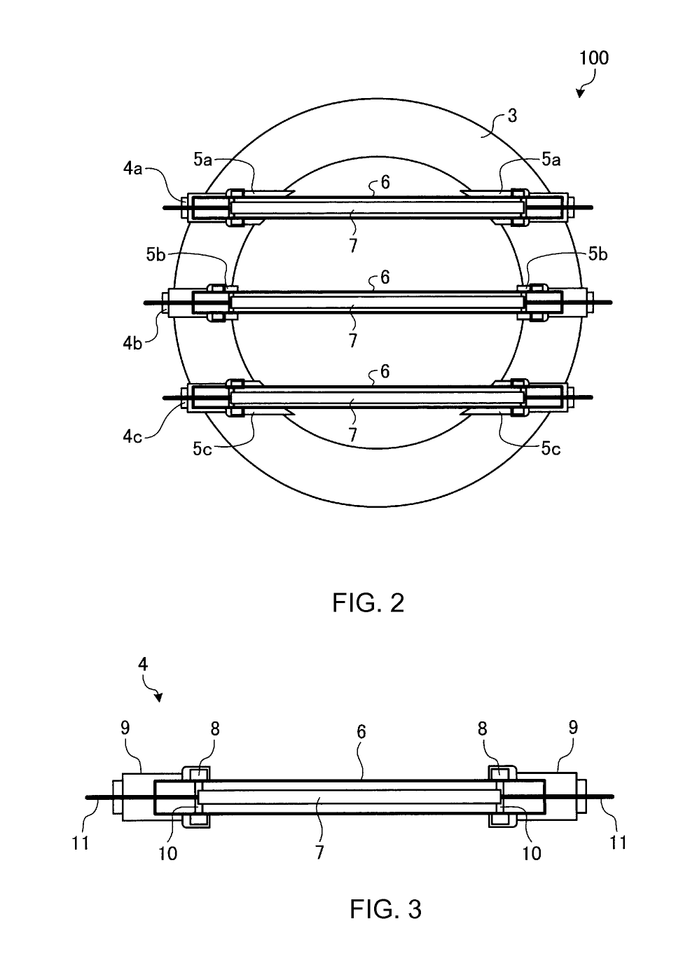

FIG. 1 is a block diagram of an ultraviolet irradiation apparatus of a first embodiment. FIG. 2 is a cross-sectional view taken along the A-A line of FIG. 1. An ultraviolet irradiation apparatus 100 of the first embodiment is configured to perform treatments such as sterilization, disinfection, and inactivation on treatment target water, and mainly includes a water passage body 20, ultraviolet irradiation tubes 4 and flange joints 3.

The water passage body 20 is a cylindrical member having paired openings (a water inlet and a water outlet) in its respective two ends. As shown in FIG. 1, treatment target water passes through the water passage body 20 in an A direction. In this embodiment, the opening into which the treatment target water flows is referred to as a “water inlet,” and the opening from which the treatment target water flows out is referred to as a “water outlet.” It should be noted that although with regard to FIG. 1, descriptions will be provided for the case where the treatment target water flows in the A direction, the treatment target water may flow in a direction opposite to the A direction.

In addition, as shown in FIG. 2, a total of 6 through-holes are formed in the water passage body 20: in a half of the water passage body 20, three through-holes are formed along the circumference of the cylinder; and in the opposite half of the water passage body 20, the other three through-holes are formed along the circumference of the cylinder. Bushings 5a, 5b, 5c are fixed to these 6 through-holes by penetrating the 6 through-holes. Ultraviolet irradiation tubes 4a, 4b, 4c are respectively placed in these through-holes.

As shown in FIG. 3, each ultraviolet irradiation tube 4 is formed mainly from an ultraviolet lamp 7 and a quartz glass tube 6. The ultraviolet lamp 7 is housed in the quartz glass tube 6. As shown in FIG. 1 and FIG. 2, the ultraviolet irradiation apparatus 100 includes the three ultraviolet irradiation tubes 4a, 4b, 4c. It should be noted that although the ultraviolet irradiation apparatus of this embodiment includes the three ultraviolet irradiation tubes, the ultraviolet irradiation apparatus may include one, two, four or more ultraviolet irradiation tubes.

The ultraviolet lamp 7 emits ultraviolet rays to the treatment target water, which passes through the water passage body 20. The length of a light-emitting portion for emitting ultraviolet rays in the ultraviolet lamp 7 is termed as a “light-emitting length.” The light-emitting length of the ultraviolet lamp 7 to be used is in a range from −10% to +10% of an inner diameter of the water passage body 20. In addition, the ultraviolet lamp 7 emits ultraviolet rays with a wavelength in a range including 200 nm to 300 nm. The quartz glass tube 6 houses the ultraviolet lamp 7, and thus protects the ultraviolet lamp 7.

The ultraviolet irradiation tubes 4a, 4b, 4c are provided on the plane which intersects the A direction from the water inlet to the water outlet, and are provided in parallel to one another. To put it specifically, the three ultraviolet irradiation tubes 4a, 4b, 4c are arranged in parallel to one another on the plane orthogonal to the A direction. In other words, as shown in FIG. 1, the ultraviolet irradiation tubes 4a, 4b, 4c are arranged in line on the cross-sectional line A-A. Furthermore, the ultraviolet irradiation tubes 4a, 4b, 4c are attached to the water passage body 20 with the two end portions of each of the ultraviolet irradiation tubes 4a, 4b, 4c inserted in corresponding ones of the bushings 5a, 5b, 5c which are fixed to the 6 through-holes provided in the water passage body 20.

Moreover, triangular grooves for O-rings, which are not illustrated, are formed outward of the bushings 5a, 5b, 5c and in the vicinities of the end portions of the ultraviolet irradiation tubes 4a, 4b, 4c. The ultraviolet irradiation tubes 4a, 4b, 4c are water-tightly fixed to the water passage body 20 by: inserting the O-rings in the triangular grooves; and fixing the O-rings with O-ring stoppers 8 (see FIG. 3).

The two end portions of the water passage body 20 are provided with paired flange joints 3, respectively. The flange joints 3 are projecting edge portions which function as joints for connecting the ultraviolet irradiation apparatus 100 to a pipe of a water treatment plant or the like, or to another ultraviolet irradiation apparatus. In addition, each flange joint 3 is a circular, plate-shaped connecting joint in which a circular opening is formed. In other words, the flange joints 3 project outward of the paired openings from the peripheral edges of the paired openings of the water passage body 20, respectively. The flange joint 3a is formed in the water-inlet side of the water passage body 20, and the flange joint 3b is formed in the water-outlet side of the water passage body 20. Furthermore, the inner diameter of the opening of each flange joint 3 is equal to or less than the inner diameter of the opening of the water passage body 20. Moreover, the outer diameter of each flange joint 3 is greater than the outer diameters of the respective two end portions of the water passage body 20. In the ultraviolet irradiation apparatus 100 of this embodiment, the flange joints 3a, 3b are attached to the opening end surfaces of the respective two end portions of the water passage body 20. Besides, the flange joints 3a, 3b have a size which enables the flange joints 3a, 3b to be connected to pipes of an existing water treatment plant and the like. The flanges joints 3a, 3b are formed, for example, in compliance with the standard specifications. Each flange joint 3 and the water passage body 20 are arranged with the center of the opening of the flange joint 3 coinciding with the center of the opening of the water passage body 20.

Next, detailed descriptions will be provided for the ultraviolet irradiation tubes 4. FIG. 3 shows the configuration of one ultraviolet irradiation tube 4. Each ultraviolet irradiation tube 4 includes the O-ring stoppers 8, caps 9, and positioning pieces 10 in addition to the quartz glass tube 6 and the ultraviolet lamp 7 which have been mentioned above. Furthermore, as shown in FIG. 3, electric wires 11 for supplying electric power to the ultraviolet lamp 7 are connected to the respective two end portions of the ultraviolet lamp 7.

The O-ring stoppers 8 stop the above-mentioned O-rings. The positioning pieces 10 are attached to the respective two ends of the ultraviolet lamp 7, and thus hold the ultraviolet lamp 7 in the center of the quartz glass tube 6.

The caps 9 are attached to the respective two end portions of the quartz glass tube 6. The caps 9 protect the two end portions of the quartz glass tube 6, and prevent ultraviolet rays, which are radiated from the ultraviolet lamp 7, from leaking to the outside. A conduit hole is formed in each cap 9, and the electrical wire 11 passes through the conduit hole.

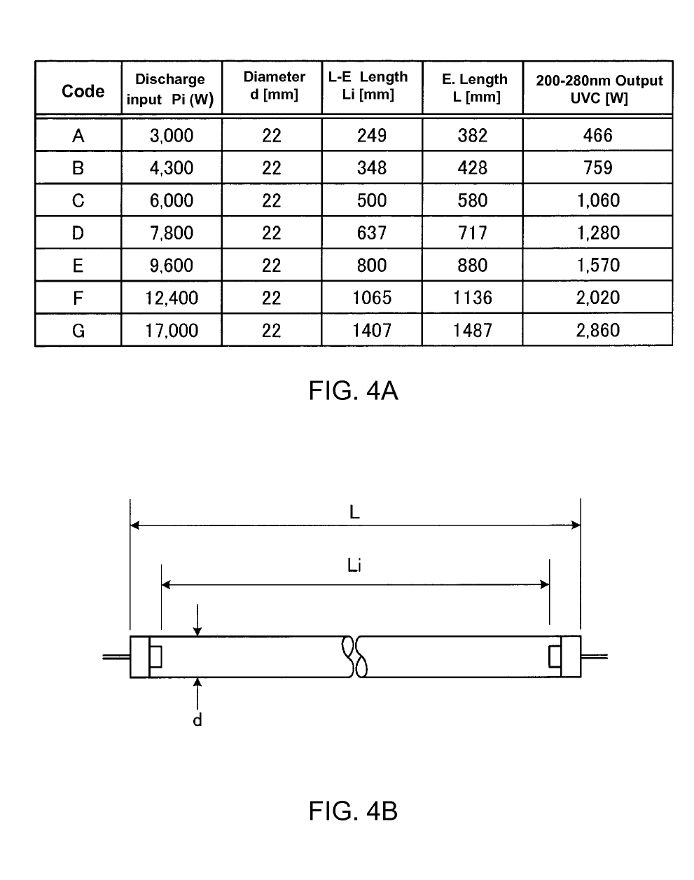

Next, descriptions will be provided for how the ultraviolet lamps 7 are selected for their use in the ultraviolet irradiation apparatus 100. FIGS. 4A and 4B explain the dimensions of the ultraviolet lamps. FIG. 4A shows examples of the dimensions of medium-pressure ultraviolet lamps. FIG. 4B explains places at which the dimensions of each ultraviolet lamp should be measured. In FIG. 4B, reference sign L denotes the overall length of the ultraviolet lamp 7; Li, the light-emitting length; and d, the diameter of the tube.

Discharge input power Pi (W) is a value representing the electric power supplied to the ultraviolet lamp. As shown in FIG. 4A, as the discharge input power Pi becomes larger, the light-emitting length Li becomes longer, and the ultraviolet output with a wavelength of 200 nm to 280 nm UVC (W) becomes larger as well.

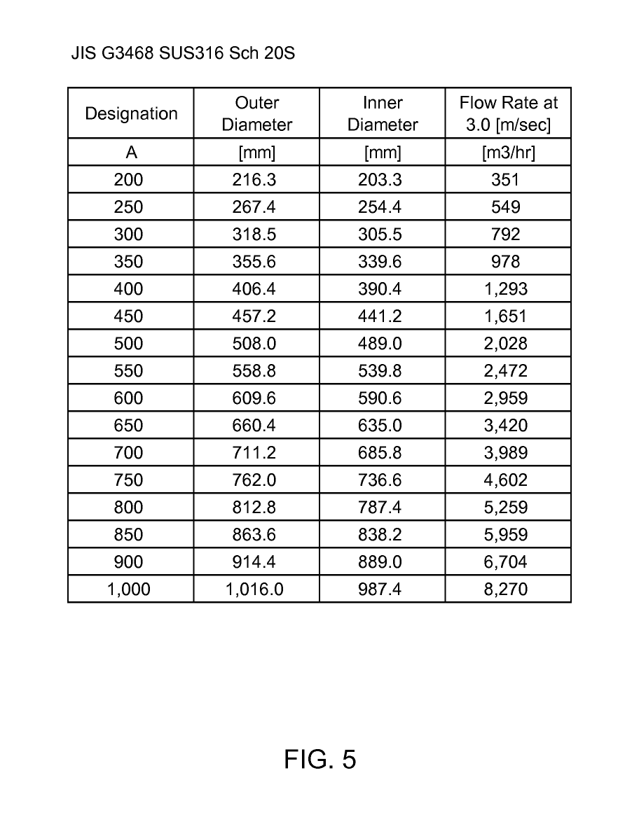

On the other hand, with the treatment flow rate and a reduction in the pressure loss of a pipe taken into consideration, the diameter of the pipes used in a water treatment plant and the like are usually selected so that the flow speed of the water passage should be in a range from approximately 2.5 m/sec to 3.0 m/sec. FIG. 5 is a table showing dimensions of pipes specified under the JIS (Japanese Industrial Standards) and their flow rates at a flow speed of 3.0 m/sec.

The water passage body 20, whose inner diameter matches any one of the inner diameters of the respective standardized pipes listed in FIG. 5, is used for the ultraviolet irradiation apparatus 100 of this embodiment. The ultraviolet irradiation apparatus 100 is formed from the water passage body 20 and the ultraviolet lamps 7 in combination. In each combination, the inner diameter of the water passage body 20 and the light-emitting length of each ultraviolet lamp 7 are equal to each other.

Here, specific examples of what ultraviolet lamps 7 should be selected will be shown. In a case where, for example, the water passage body 20 whose inner diameter is equal to the inner diameter (254.4 mm) of a pipe whose JIS designation is 250A in FIG. 5 is used, Lamp A whose light-emitting length Li is closest to the inner diameter of the water passage body 20 is selected by referring to FIG. 4A. The light-emitting length Li of Lamp A is 249 mm.

In addition, in a case where, for example, the water passage body 20 whose inner diameter is equal to the inner diameter (489.0 mm) of a pipe whose JIS designation is 500A in FIG. 5 is used, Lamp C whose light-emitting length Li is closest to the inner diameter of the water passage body 20 is selected by referring to FIG. 4A. The light-emitting length Li of Lamp C is 500 mm.

Furthermore, in a case where, for example, the water passage body 20 whose inner diameter is equal to the inner diameter (987.4 mm) of a pipe whose JIS designation is 1000A in FIG. 5 is used, Lamp F whose light-emitting length Li is closest to the inner diameter of the water passage body 20 is selected by referring to FIG. 4A. The light-emitting length Li of Lamp F is 1065 mm.

In the thus-configured ultraviolet irradiation apparatus 100 of this embodiment, first of all, the treatment target water flows into the water passage body 20 via the water inlet to which the flange joint 3a is connected, and flows inside the water passage body 20 in the A direction. The ultraviolet lamps 7 in the respective ultraviolet irradiation tubes 4, which are arranged in parallel to one another on the plane orthogonal to the A direction, emit ultraviolet rays to the treatment target water. Thereby, bacteria included in the treatment target water are sterilized, disinfected and inactivated. Thereafter, the treated water flows out from the water outlet to which the flange joint 3b is connected.

As described above, the ultraviolet irradiation apparatus 100 of the first embodiment has the flange joints 3, which are connectable to pipes of an existing water treatment plant, in the respective two ends of the water passage body 20; and the ultraviolet irradiation apparatus 100 uses the water passage body 20 whose diameter matches the diameter of pipes of the existing water treatment plant. This enables the ultraviolet irradiation apparatus 100 of the first embodiment to be easily installed in an existing water treatment plant. In addition, because the ultraviolet irradiation tubes 4a, 4b, 4c are arranged on the plane orthogonal to the direction from the water inlet to the water outlet, the length of the ultraviolet irradiation apparatus 100 can be made shorter. For this reason, the ultraviolet irradiation apparatus 100 can be set up in even a narrow place.

Moreover, the ultraviolet irradiation apparatus 100 enables the flange joints 3 to be connected to other ultraviolet irradiation apparatuses. This makes it possible to adjust the amount of ultraviolet irradiation depending on how many ultraviolet irradiation apparatuses are connected together; and thereby to emit a necessary amount of ultraviolet rays to the treatment target water.

In addition, because the ultraviolet irradiation apparatus 100 includes the ultraviolet lamps 7 whose light-emitting length is equal to the inner diameter of the water passage body 20, ultraviolet rays are emitted to the treatment target water without waste. This makes it possible for the ultraviolet irradiation apparatus 100 to efficiently perform disinfection (sterilization) treatment or oxidization treatment on microorganisms and substances to be treated, such as organic matter and inorganic matter, which are included in the treatment target water. In the meantime, the light-emitting length of the ultraviolet lamps can be unequal to the inner diameter of the water passage body 20 due to the standards of the ultraviolet lamps and the standards of the pipes. For this reason, the light-emitting length of the ultraviolet lamps is set in a range of −10% to +10% of the inner diameter of the water passage body 20 for a practical purpose. Even when the ultraviolet lamps whose light-emitting length is set in this range are used, the ultraviolet irradiation apparatus 100 is capable of efficiently performing disinfection (sterilization) treatment or oxidization treatment on microorganisms and substances to be treated, such as organic matter and inorganic matter, which are included in the treatment target water, as in the case where the light-emitting length is equal to the inner diameter of the water passage body 20.

In this embodiment, the three ultraviolet irradiation tubes are placed in parallel to one another. However, the ultraviolet irradiation tubes do not have to be placed in parallel to one another. For example, the placement may be achieved, in which: two ultraviolet irradiation tubes may be arranged in the form of the letter V on the plane.

### Second Embodiment

In the ultraviolet irradiation apparatus of the first embodiment, the water passage body is cylindrical. In the ultraviolet irradiation apparatus of the second embodiment, however, part of the water passage body has a rectangular tubular shape in which each of the cross-sectional external and internal shapes of the part is rectangular.

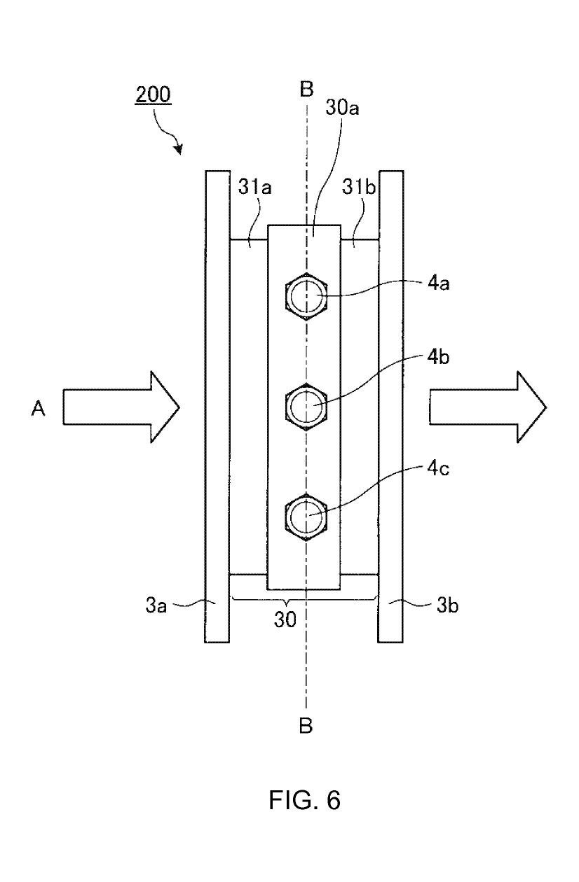

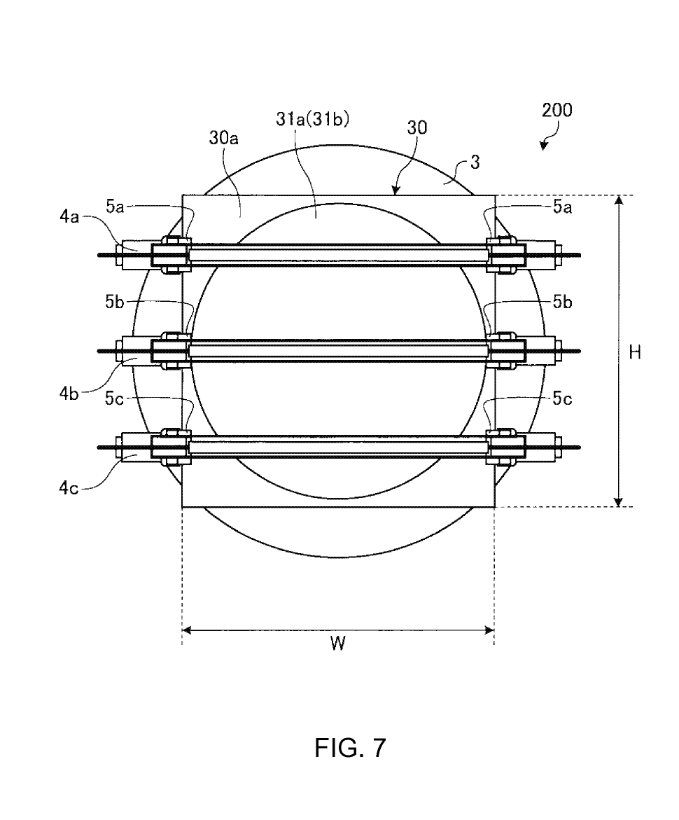

FIG. 6 is a block diagram of the ultraviolet irradiation apparatus of the second embodiment. FIG. 7 is a cross-sectional view taken along the B-B line of FIG. 6. The ultraviolet irradiation apparatus 200 of the second embodiment is configured to perform treatments such as sterilization, disinfection, and inactivation on treatment target water, and mainly includes a water passage body 30, ultraviolet irradiation tubes 4 and flange joints 3.

The water passage body 30 is a tubular member having paired openings (a water inlet and a water outlet) in its respective two ends. Water to be treated passes through the water passage body 30 in an A direction. The two end portions of the water passage body 30 are shaped like a cylinder. The water passage body 30 has a rectangular portion 30a, whose cross-sectional external and internal shapes are rectangular, around its center in the A direction. In this embodiment, the opening into which the treatment target water flows is referred to as a “water inlet,” and the opening from which the treatment target water flows out is referred to as a “water outlet.” It should be noted that although with regard to FIG. 6, descriptions will be provided for the case where the treatment target water flows in the A direction, the treatment target water may flow in a direction opposite to the A direction.

In addition, a total of 6 through-holes are formed in the water passage body 30 with three through-holes in each of the paired opposed sides of the rectangular portion 30a. These paired sides are vertical to the opening surfaces of the openings. Bushings 5a, 5b, 5c are fixed to the 6 through-holes by penetrating the 6 through-holes. Furthermore, the internal dimension of the water passage body 30 between the opposed sides of the rectangular portion 30a in which the through-holes are formed is equal to the light-emitting length of the ultraviolet lamps 7.

Moreover, the water-inlet-side end portion 31a and water-outlet-side end portion 31b of the water passage body 30 each have an outer diameter equal to or less than the shorter one of internal dimensions of the rectangular portion 30a between its two opposed sides and between its other two opposed sides in the water passage body 30. To put it specifically, the outer diameter of the end portions 31a, 31b of the water passage body 30 is equal to or less than the shorter one of first and second internal dimensions of the rectangular portion 30a, where the first internal dimension denotes a dimension between one pair of the opposed sides (width, denoted by reference sign W in FIG. 7) and the second internal dimension denotes a dimension orthogonal to the first internal dimension, i.e., an internal dimension of the rectangular portion 30a between the other pair of the opposed sides in which no through-holes are formed (height, denoted by reference sign H in FIG. 7). Furthermore, the diameter of each of the openings in the end portions 31a, 31b, that is to say, the inner diameter of the water passage body 30 in the end portions 31a, 31b is equal to or less than the light-emitting length of the ultraviolet lamps 7.

Ultraviolet irradiation tubes 4 are each formed mainly from one ultraviolet lamp 7 and a quartz glass tube 6, are identical to those of the first embodiment, and thus descriptions will be omitted. It should be noted that as described above, the light-emitting length of each ultraviolet lamp 7 of this embodiment is equal to the width (denoted by reference sign W in FIG. 7) of the rectangular portion 30a of the water passage body 30, and is equal to or greater than the inner diameter of the water passage body 30 in the end portions 31a, 31b.

The two end portions of the water passage body 30 are provided with paired flange joints 3, respectively. The flange joints 3 are projecting edge portions which function as joints for connecting the ultraviolet irradiation apparatus 200 to a pipe of a water treatment plant or the like, or to another ultraviolet irradiation apparatus. In addition, each flange joint 3 is a circular, plate-shaped connecting joint in which an opening is formed. In other words, the flange joints 3 project outward of the paired openings from the peripheral edges of the paired openings of the water passage body 30, respectively. The flange joint 3a is formed in the water-inlet-side end portion 31a of the water passage body 30, and the flange joint 3b is formed in the water-outlet-side end portion 31b of the water passage body 30. Furthermore, the inner diameter of the opening of each flange joint 3 is equal to or less than the inner diameter of the opening of the water passage body 30. Moreover, the outer diameter of each flange joint 3 is greater than the outer diameters of the respective end portions 31a, 31b of the water passage body 30. The flange joints 3 are attached to the water passage body 30, as in the case of the first embodiment.

The detail of each ultraviolet irradiation tube 4 and the way how the ultraviolet lamps 7 are selected are identical to those of the first embodiment, and thus descriptions will be omitted.

In the thus-configured ultraviolet irradiation apparatus 200 of this embodiment, first of all, the treatment target water flows into the water passage body 30 via the water inlet to which the flange joint 3a is connected, and flows inside the end portion 31a, the rectangular portion 30a and the end portion 31b of the water passage body 30 in the A direction. The ultraviolet lamps 7 in the respective ultraviolet irradiation tubes 4, which are arranged in parallel to one another on the plane orthogonal to the A direction, emit ultraviolet rays to the treatment target water. Thereby, bacteria included in the treatment target water are sterilized, disinfected and inactivated. Thereafter, the treated water flows out from the water outlet to which the flange joint 3b is connected.

As described above, the ultraviolet irradiation apparatus 200 of the second embodiment has the flange joints 3, which are connectable to pipes of an existing water treatment plant, in the respective end portions 31a, 31b; and the ultraviolet irradiation apparatus 200 uses the water passage body 30 whose diameter matches the diameter of pipes of the existing water treatment plant. This enables the ultraviolet irradiation apparatus 200 of the second embodiment to be easily installed in an existing water treatment plant. In addition, because the ultraviolet irradiation tubes 4a, 4b, 4c are arranged in parallel to one another on the plane orthogonal to the direction from the water inlet to the water outlet, the length of the ultraviolet irradiation apparatus 200 can be made shorter. For this reason, the ultraviolet irradiation apparatus 200 can be set up in even a narrow place.

Moreover, the ultraviolet irradiation apparatus 200 enables the flange joints 3 to be connected to other ultraviolet irradiation apparatuses. This makes it possible to adjust the amount of ultraviolet irradiation depending on how many ultraviolet irradiation apparatuses are connected together; and thereby to emit a necessary amount of ultraviolet rays to the treatment target water.

In addition, because the ultraviolet irradiation apparatus 200 includes the ultraviolet lamps 7 whose light-emitting length is equal to the internal dimension of the water passage body 30 in the rectangular portion 30a, which is measured in the same direction as the ultraviolet lamps 7 extend, ultraviolet rays are emitted to the treatment target water without waste. This makes it possible for the ultraviolet irradiation apparatus 200 to efficiently perform disinfection (sterilization) treatment or oxidization treatment on microorganisms and substances to be treated, such as organic matter and inorganic matter, which are included in the treatment target water.

### Third Embodiment

In an ultraviolet irradiation apparatus of this embodiment, a plurality of ultraviolet irradiation portions are connected together.

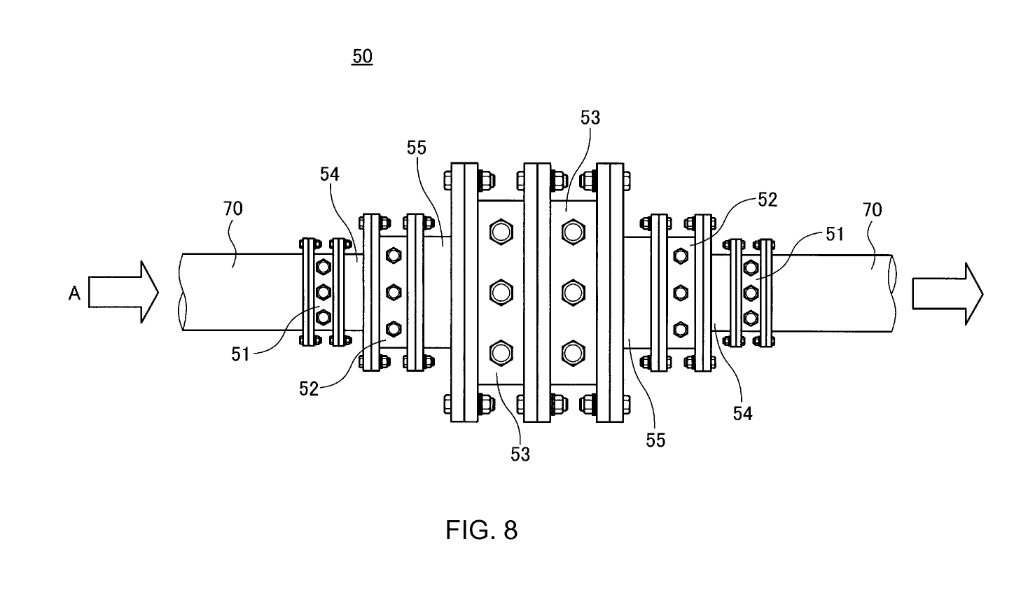

FIG. 8 is a block diagram of the ultraviolet irradiation apparatus of the third embodiment. The ultraviolet irradiation apparatus 50 of the third embodiment mainly includes: three types of ultraviolet irradiation portions 51, 52, 53 each including a water passage body of a different diameter; connecting pipes 54 for connecting the ultraviolet irradiation portions 51 and the ultraviolet irradiation portions 52, respectively; and connecting pipes 55 for connecting the ultraviolet irradiation portions 52 and the ultraviolet irradiation portions 53, respectively.

In this respect, because the structures and functions of the ultraviolet irradiation portions 51, 52, 53 are the same as those of the ultraviolet irradiation apparatus 100 of the first embodiment, descriptions will be omitted. Additionally, in the following descriptions, the constituent members of the ultraviolet irradiation portions 51, 52, 53 are denoted by the same reference numerals as those of the ultraviolet irradiation apparatus 100. Incidentally, the flange joints 3 of the ultraviolet irradiation portions 51, 52, 53 of this embodiment are provided with bolt holes, penetrating through the flange joints 3, for fixing the flange joints 3 with bolts.

Furthermore, the ultraviolet irradiation apparatus 50 includes a total of 6 ultraviolet irradiation portions, which are two ultraviolet irradiation portions 51; two ultraviolet irradiation portions 52; and two ultraviolet irradiation portions 53. Moreover, the sizes of the internal diameters of the water passage bodies 20 are different among the ultraviolet irradiation portions 51, 52, 53. First of all, the inner diameter of the water passage body 20 of each ultraviolet irradiation portion 51 is equal to the inner diameter of each pipe 70. In addition, the inner diameter of the water passage body 20 of each ultraviolet irradiation portion 52 is larger than the inner diameter of the water passage body 20 of each ultraviolet irradiation portion 51. Furthermore, the inner diameter of the water passage body 20 of each ultraviolet irradiation portion 53 is larger than the inner diameter of the water passage body 20 of each ultraviolet irradiation portion 52.

Each connecting pipe 54 is placed between the ultraviolet irradiation portions 51 and 52 to connect the portions together. Meanwhile, each connecting pipe 55 is placed between the ultraviolet irradiation portions 52 and 53 to connect the portions together.

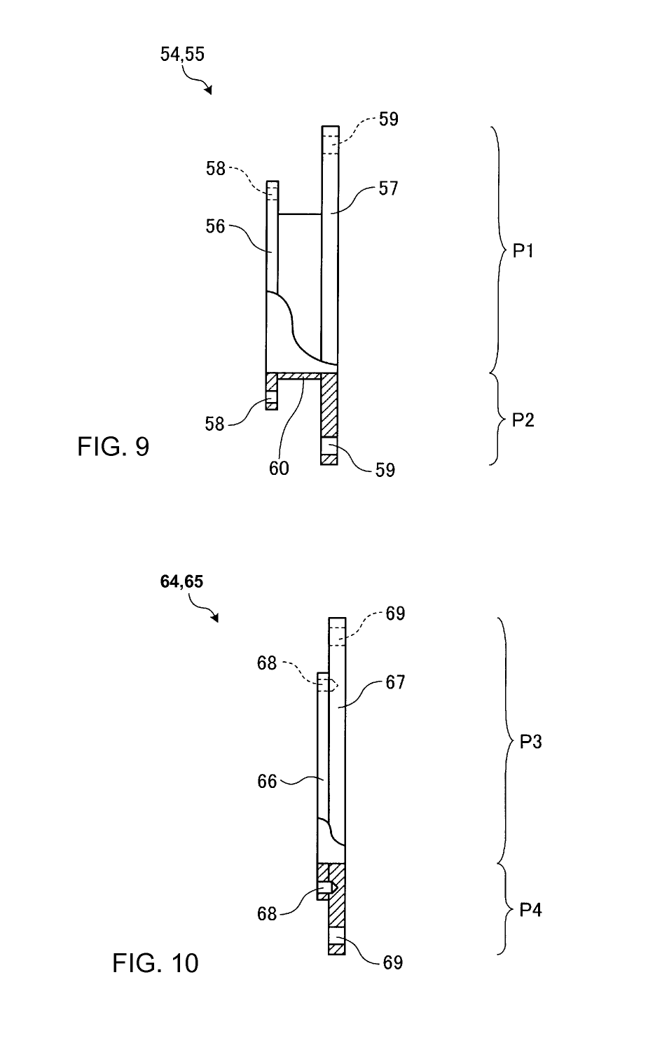

Here, detailed descriptions will be provided for the constitution of the connecting pipes 54, 55. FIG. 9 is a block diagram showing an example of the connecting pipes. Each of the connecting pipes 54, 55 includes a small-diameter pipe 60, a flange joint 56 and a flange joint 57. Incidentally, in FIG. 9, a section indicated by reference sign P1 is a side view of each of the connecting pipes 54, 55, and a section indicated by reference sign P2 is a cross-sectional view of each of the connecting pipes 54, 55.

The small-diameter pipe 60 is a cylindrical pipe member having paired openings in its respective two ends.

The flange joint 56 is a projecting edge portion which is placed in and connected with the end surface of one of the paired openings of the small-diameter pipe 60, and which functions as a joint. Furthermore, the flange joint 56 is a circular, plate-shaped connecting joint in which a circular opening is formed. The flange joint 56 projects outward of the opening from the peripheral edge of the opening of the small-diameter pipe 60. Moreover, the flange joint 56 is connectable to the flange joint 3a or the flange joint 3b of one of the ultraviolet irradiation portions 51, 52. Besides, the flange joint 56 is provided with a plurality of bolt holes 58 for fixing bolts at equal intervals in the same circumference.

The flange joint 57 is a projecting edge portion which is placed in and connected to the end surface of the other of the paired openings of the small-diameter pipe 60, and which functions as a joint. The flange joint 57 is a circular, plate-shaped connecting joint in which an opening is formed. The flange joint 57 projects outward of the opening from the peripheral edge of the opening of the small-diameter pipe 60. Moreover, the flange joint 57 is connectable to the flange joint 3a or the flange joint 3b of one of the ultraviolet irradiation portions 52, 53. Besides, the flange joint 57 is provided with a plurality of bolt holes 59 for fixing bolts at equal intervals in the same circumference.

In addition, the inner diameter of the opening of the flange joint 56 of each connecting pipe 54 is equal to the inner diameter of the water passage body 20 (the inner diameter of the flange joint 3) of the ultraviolet irradiation portion 51, and the outer diameter thereof is equal to the outer diameter of the flange joint 3. To put it specifically, the size of the flange joint 56 of the connecting pipe 54 is equal to the size of the flange joint 3 of the ultraviolet irradiation portion 51. In addition, the inner diameter of the opening of the flange joint 57 of the each connecting pipe 54 is equal to the inner diameter of the water passage body 20 (the inner diameter of the flange joint 3) of the ultraviolet irradiation portion 51, and the outer diameter thereof is equal to the outer diameter of the flange joint 3 of the ultraviolet irradiation portion 52. Furthermore, the inner diameter of the opening of the flange joint 56 of the connecting pipe 55 is equal to the inner diameter of the water passage body 20 (the inner diameter of the flange joint 3) of the ultraviolet irradiation portion 52, and the outer diameter thereof is equal to the outer diameter of the flange joint 3 of the ultraviolet irradiation portion 52. To put it specifically, the size of the flange joint 56 of the connecting pipe 55 is equal to the size of the flange joint 3 of the ultraviolet irradiation portion 52. Moreover, the inner diameter of the opening of the flange joint 57 of the connecting pipe 55 is equal to the inner diameter of the water passage body 20 (the inner diameter of the flange joint 3) of the ultraviolet irradiation portion 52, and the outer diameter thereof is equal to the outer diameter of the flange joint 3 of the ultraviolet irradiation portion 53.

Next, descriptions will be provided for how the connecting pipes 54, 55 and the ultraviolet irradiation portions 51, 52, 53 are arranged. As shown in FIG. 8, in the ultraviolet irradiation apparatus 50, the ultraviolet irradiation portion 51, the connecting pipe 54, the ultraviolet irradiation portion 52, the connection pipe 55, the ultraviolet irradiation portion 53, the ultraviolet irradiation portion 53, the connecting pipe 55, the ultraviolet irradiation portion 52, the connecting pipe 54 and the ultraviolet irradiation portion 51 are arranged between the two pipes 70 in this order from one to the other one of the pipes 70.

In addition, the flange joint provided to the end portion of a first pipe 70 and the flange joint 3a of a first ultraviolet irradiation portion 51 are fixed to and connected to each other with the bolts penetrated through the respective bolt holes; the flange joint 3b of the first ultraviolet irradiation portion 51, the flange joint 56 of a first connecting pipe 54; the flange joint 57 of the first connecting pipe 54, the flange joint 3a of a first ultraviolet irradiation portion 52; the flange joint 3b of the first ultraviolet irradiation portion 52, the flange joint 56 of a first connecting pipe 55; the flange joint 57 of the first connecting pipe 55, the flange joint 3a of a first ultraviolet irradiation portion 53; and the flange joint 3b of the first ultraviolet irradiation portion 53, the flange joint 3a of a second ultraviolet irradiation portion 53. With regard to the rest, similarly, the second ultraviolet irradiation portion 53 and a second connecting pipe 55 are connected together; the second connecting pipe 55, a second ultraviolet irradiation portion 52; the second ultraviolet irradiation portion 52, a second connecting pipe 54; the second connecting pipe 54, a second ultraviolet irradiation portion 51; and the second ultraviolet irradiation portion 51, a second pipe 70.

In the thus-configured ultraviolet irradiation apparatus 50 of this embodiment, first of all, treatment target water, which flows out of the first pipe 70, flows into the first ultraviolet irradiation portion 51, and thereafter sequentially flows through the first connecting pipe 54, the first ultraviolet irradiation portion 52, the first connecting pipe 55, the first ultraviolet irradiation portion 53, the second ultraviolet irradiation portion 53, the second connecting pipe 55, the second ultraviolet irradiation portion 52, the second connecting pipe and the second ultraviolet irradiation portion 51. Subsequently, the treatment target water flows out into the second pipe 70. While the treatment target water is passing through the ultraviolet irradiation portions 51, 52, 53, 53, 52, 51, bacteria included in the treatment target water are sterilized, disinfected, and inactivated, by ultraviolet rays emitted from the ultraviolet lamps 7 of the ultraviolet irradiation tubes 4 arranged in parallel to one another on the plane orthogonal to the A direction.

As described above, the ultraviolet irradiation apparatus 50 of the third embodiment includes the plurality of ultraviolet irradiation portions; and the ultraviolet irradiation portion on each of the two ends of the ultraviolet irradiation apparatus 50 includes the flange joint 3 which is connectable to a pipe 70 of an existing water treatment plant. This enables the ultraviolet irradiation apparatus 50 of the third embodiment to be easily installed in an existing water treatment plant. In addition, in each of the ultraviolet irradiation portions 51, 52, 53, 53, 52, 51 of the ultraviolet irradiation apparatus 50, the ultraviolet irradiation tubes 4a, 4b, 4c are arranged in parallel to one another on the plane orthogonal to the direction from the water inlet to the water outlet. For this reason, the ultraviolet irradiation portions 51, 52, 53, 53, 52, 51 are short in length, and the ultraviolet irradiation apparatus 50 is short in length. Accordingly, this embodiment makes it possible to set up the ultraviolet irradiation apparatus 50, which includes the plurality of ultraviolet irradiation portions, in even a narrow place.

Moreover, in the ultraviolet irradiation apparatus 50, the plurality of ultraviolet irradiation portions 51, 52, 53 are connected together with one of the connecting pipes 54, 55 interposed between each neighboring two of the ultraviolet irradiation portions 51, 52, 53. This makes the ultraviolet irradiation apparatus 50 capable of: adjusting the amount of ultraviolet irradiation depending on how many ultraviolet irradiation portions are connected together; and emitting a necessary amount of ultraviolet irradiation to the treatment target water.

In addition, the ultraviolet irradiation portions 51, 52, 53, 53, 52, 51 each include the ultraviolet lamp 7 whose light-emitting length is equal to the inner diameter of the water passage body 20. For this reason, ultraviolet rays are emitted to the treatment target water without waste. This makes it possible for the ultraviolet irradiation apparatus 50 to efficiently perform disinfection (sterilization) treatment or oxidization treatment on microorganisms and substances to be treated, such as organic matter and inorganic matter, which are included in the treatment target water.

Moreover, in a case where a large amount of ultraviolet irradiation is required with only a small flow rate, the ultraviolet irradiation apparatus 50 enables installation of the ultraviolet irradiation portions 53 each including the ultraviolet lamps 7 with a larger ultraviolet output. This makes it possible to reduce the number of ultraviolet lamps 7 used in the ultraviolet irradiation apparatus 50 of this embodiment. As a result, it is possible to realize the ultraviolet irradiation apparatus 50 with a simple structure, and to produce a space-saving and cost-saving ultraviolet irradiation apparatus 50.

Furthermore, in the ultraviolet irradiation apparatus 50, a pseudo-expansion pipe is formed in its inlet side of the treatment target water (in its water-inlet side), and a pseudo-reduction pipe is formed in its outlet side of the treatment target water (in its water-outlet side). For this reason, the ultraviolet irradiation apparatus 50 is capable of: reducing the pressure loss which occurs due to a sudden expansion and a sudden reduction in the passage; and accordingly reducing an uneven distribution of the treatment target water inside the ultraviolet irradiation apparatus 50. This makes the ultraviolet irradiation apparatus 50 of this embodiment capable of achieving efficient ultraviolet irradiation.

### Modification 1 of the Third Embodiment

In the ultraviolet irradiation apparatus of the third embodiment, the plurality of ultraviolet irradiation portions are connected with the connecting pipe including the small-diameter pipe interposed between each neighboring two ultraviolet irradiation portions. Instead of the connecting pipe, however, a connecting joint not including any small-diameter pipe may be used. In other words, the plurality of ultraviolet irradiation portions maybe connected with the connecting joint not including any small-diameter pipe interposed between each neighboring two ultraviolet irradiation portions. Constitution of ultraviolet irradiation portions 51, 52, 53, 53, 52, 51 in an ultraviolet irradiation apparatus 50 of this modification are identical to those of the ultraviolet irradiation apparatus 50 of the third embodiment. Descriptions will be hereinbelow provided for the constitution of the connecting joints which are provided instead of the connecting pipes.

FIG. 10 is a block diagram showing an example of the connecting joints. A connecting joint 64 of this modification is provided between and connects an ultraviolet irradiation portion 51 and an ultraviolet irradiation portion 52; and a connecting joint 65 of this modification is provided between and connects the ultraviolet irradiation portion 52 and an ultraviolet irradiation portion 53.

As shown in FIG. 10, each of the connecting joints 64, 65 includes a flange joint 66 and a flange joint 67. Incidentally, in FIG. 10, a portion indicated by reference sign P3 is a side view of the connecting joints 64, 65, and a portion indicated by reference sign P4 is a cross-sectional view of the connecting joint 64, 65.

The flange joint 66 is a projecting edge portion which functions as a joint. The flange joint 66 is a circular, plate-shaped connecting joint in which a circular opening is formed, and projects outward of the opening from the peripheral edge of the opening. In addition, the flange joint 66 is connectable to the flange joint 3a or the flange joint 3b of any one of the ultraviolet irradiation portions 51, 52. Furthermore, a plurality of screw holes 68, which penetrate through the plate-shaped body of the flange joint 66, are provided in the flange joint 66 at equal intervals on the same circumference.

The flange joint 67 is a projecting edge portion which functions as a joint. The flange joint 67 is a circular, plate-shaped connecting joint in which a circular opening is formed, and projects outward of the opening from the peripheral edge of the opening. The flange joint 67 is made from the same material as is the flange joint 66. In addition, the flange joint 67 is connectable to the flange joint 3a or the flange joint 3b of any one of the ultraviolet irradiation portions 52, 53. Furthermore, a plurality of bolt holes 69 for the respective fixing bolts are provided in the flange joint 67 at equal intervals in the same circumference. The bolt holes 69 penetrate through the plate-shaped body of the flange joint 67. Moreover, in the flange joint 67, screw holes 68 are formed inside of the bolt holes 69. The screw holes 68 of the flange joint 67 are connected to the screw holes 68 of the flange joint 66. These screw holes 68 do not penetrate through the plate-shaped body of the flange joint 67. Additionally, the inner diameter of the flange joint 67 is equal to the inner diameter of the flange joint 66; the outer diameter of the flange joint 67 is larger than the outer diameter of the flange joint 66; and the flange joint 66 and the flange joint 67 are coaxially connected together. Incidentally, the flange joint 66 and the flange joint 67 may be made from a unitary metal plate.

In addition, the inner diameter of the opening of the flange joint 66 of the connecting joint 64 is equal to the inner diameter of the water passage body 20 (the inner diameter of the flange joint 3) of the ultraviolet irradiation portion 51, and the outer diameter thereof is equal to the outer diameter of the flange joint 3 of the ultraviolet irradiation portion 51. Furthermore, the inner diameter of the opening of the flange joint 67 is equal to the inner diameter of the water passage body 20 (the inner diameter of the flange joint 3) of the ultraviolet irradiation portion 51, and the outer diameter thereof is equal to the outer diameter of the flange joint 3 of the ultraviolet irradiation portion 52. Moreover, the inner diameter of the opening of the flange joint 66 of the connecting joint 65 is equal to the inner diameter of the water passage body 20 (the inner diameter of the flange joint 3) of the ultraviolet irradiation portion 52, and the outer diameter thereof is equal to the outer diameter of the flange joint 3 of the ultraviolet irradiation portion 52. Besides, the inner diameter of the opening of the flange joint 67 is equal to the inner diameter of the water passage body 20 (the inner diameter of the flange joint 3) of the ultraviolet irradiation 52, and the outer diameter thereof is equal to the outer diameter of the flange joint 3 of the ultraviolet irradiation portion 53.

Moreover, the connecting of the flange joint 3b of the ultraviolet irradiation portion 51 or the flange joint 3b of the ultraviolet irradiation portion 52 to the flange joint 66 of the connecting joint 64 is achieved by: screwing the bolts to the respective screw holes 68 of the flange joint 66; and further screwing the bolts to the respective screw holes 68 of the flange joint 67. In addition, the connecting of the flange joint 3a of the ultraviolet irradiation portion 52 or the flange joint 3a of the ultraviolet irradiation portion 53 to the flange joint 67 of the connecting joint 64 is achieved by screwing the bolts. This modification has the same effects as the third embodiment.

### Modification 2 of the Third Embodiment

In the ultraviolet irradiation apparatus of the third embodiment, the plurality of ultraviolet irradiation portions, whose water passage bodies are different in inner diameter from one another, are connected with a connecting pipe interposed between neighboring two ultraviolet irradiation portions. In a case where, however, a plurality of ultraviolet irradiation portions, whose water passage bodies are equal in inner diameter to one another, are connected together, the plurality of ultraviolet irradiation portions may be connected directly with no connecting member like the connecting pipe interposed between neighboring ultraviolet irradiation portions.

To put it specifically, in a case where a plurality of ultraviolet irradiation apparatuses 100 of the first embodiment are connected together as ultraviolet irradiation portions, the flange joint 3a of one ultraviolet irradiation potion is connected to the flange joint 3a or the flange joint 3b of another ultraviolet irradiation portion. In addition, the flange joint 3b of one ultraviolet irradiation portion is connected to the flange joint 3a or the flange joint 3b of another ultraviolet irradiation portion. By this, the plurality of ultraviolet irradiation portions can be connected together depending on the necessary amount of ultraviolet irradiation. Incidentally, with regard to a connecting method, the plurality of ultraviolet irradiation portions may be fixed together with bolts, or may be bonded together by welding.

Moreover, as ultraviolet irradiation portions, a plurality of ultraviolet irradiation apparatuses 100 of the first embodiment are connected together in the third embodiment, Modification 1 of the third embodiment, and Modification 2 of the third embodiment. Instead, however, a plurality of ultraviolet irradiation apparatuses 200 of the second embodiment may be connected together.

In the ultraviolet irradiation apparatus of any one of the foregoing embodiments and their modifications, the ultraviolet irradiation tubes are placed on the plane orthogonal to the direction from the water inlet to the water outlet. This makes it possible to make the length of the ultraviolet irradiation apparatus shorter. Accordingly, the ultraviolet irradiation apparatus can be set up in even a narrow place.

Furthermore, in the ultraviolet irradiation apparatus of any one of the foregoing embodiments and their modifications, the paired openings of the water passage body have their respective paired flange joints. This makes it possible to adjust the amount of ultraviolet irradiation by connecting two or more ultraviolet irradiation apparatuses together.

Moreover, the ultraviolet irradiation apparatus can be easily installed in an existing water treatment plant, in a case where: the ultraviolet irradiation apparatus has the flange joints, which are connectable to pipes of the existing water treatment plant, in the two ends of the water passage body; and the ultraviolet irradiation apparatus uses the water passage body whose diameter coincides with the diameters of the pipes of the existing water treatment plant.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ultraviolet irradiation apparatus comprising:
a cylindrical water passage body through which treatment target water passes, and which has paired openings in its respective two end portions;
at least one ultraviolet irradiation member provided inside the water passage body on a plane orthogonal to a direction from one to the other of the openings, and configured to emit ultraviolet rays to the treatment target water passing through the water passage body; and
paired flange joints projecting from peripheral edges of the paired openings of the water passage body outward of the openings, respectively.

2. The ultraviolet irradiation apparatus of claim 1, wherein the paired openings in the two end portions of the water passage body each have a circular shape, and
the water passage body includes a rectangular tubular portion whose external and internal cross-sectional shapes are rectangular and at which the ultraviolet irradiation member are provided.

3. The ultraviolet irradiation apparatus of claim 2, wherein two end portions of the ultraviolet irradiation member are fixed to paired opposed sides of the rectangular tubular portion of the water passage body.

4. The ultraviolet irradiation apparatus of claim 1, wherein
a plurality of the ultraviolet irradiation members are provided, and
the plurality of ultraviolet irradiation members are provided in parallel to each other on the plane.

5. The ultraviolet irradiation apparatus of claim 1, wherein a light-emitting portion for emitting ultraviolet rays in the ultraviolet irradiation member has a length in a range from −10% to +10% of an inner diameter of the water passage body.

6. The ultraviolet irradiation apparatus of claim 3, wherein
a first internal dimension of the rectangular tubular portion between its opposed sides is equal to the length of the light-emitting portion for emitting the ultraviolet rays in the ultraviolet irradiation member, and
the two end portions of the water passage body each have an inner diameter equal to or less than the length of the light-emitting portion, and an outer diameter equal to or less than the shorter one of the first internal dimension and a second internal dimension of the rectangular tubular portion, the second internal dimension being orthogonal to the first internal dimension.

7. The ultraviolet irradiation apparatus of claim 1, wherein
each ultraviolet irradiation member emits ultraviolet rays whose wavelength is in a range from 200 nm to 300 nm.

8. An ultraviolet irradiation apparatus
comprising a plurality of the ultraviolet irradiation apparatuses of claim 1 which are used as ultraviolet irradiation portions,
wherein the plurality of ultraviolet irradiation portions are connected together by use of the flange joints.

9. The ultraviolet irradiation apparatus of claim 8, further comprising a connecting member which is placed between and connects two of the ultraviolet irradiation portions having the openings of the water passage body with different inner diameters.

10. The ultraviolet irradiation apparatus of claim 9, wherein the connecting member comprises:
a cylindrical tube member having openings in its respective two ends;
a first flange joint projecting from a peripheral edge of one of the openings of the tube member outward of the opening, having a circular external shape, and functioning as a joint; and
a second flange joint projecting from a peripheral edge of the other of the openings of the tube member outward of the opening, having a circular external shape and an outer diameter different from an outer diameter of the first flange joint, and functioning as a joint.

11. The ultraviolet irradiation apparatus of claim 9, wherein the connecting member comprises:
a first flange joint in which a first opening is formed, the first flange joint projecting from a peripheral edge of the first opening outward of the opening, having a circular external shape, and functioning as a joint; and
a second flange joint in which a second opening is formed, the second flange joint projecting from a peripheral edge of the second opening outward of the opening, having a circular external shape and an outer diameter different from the outer diameter of the first flange joint, and functioning as a joint.

12. The ultraviolet irradiation apparatus of claim 9, wherein
the connecting member comprising the first flange joint connected to the flange joint of one of the two ultraviolet irradiation portions, and a second flange joint connected to the flange joint of the other one of the two ultraviolet irradiation portions;
wherein the first flange joint and the second flange joint each have an opening whose inner diameter is equal to the smaller one of the inner diameters of the openings of the water passage bodies of the two ultraviolet irradiation portions.

13. The ultraviolet irradiation apparatus of claim 1, wherein the flange joint is connectable to any one of pipes specified under industrial standards.

14. The ultraviolet irradiation apparatus of claim 13, wherein
the flange joint has an opening, and
an inner diameter of the opening of the flange joint is equal to that of the opening of the water passage body and that of the pipe.

15. The ultraviolet irradiation apparatus of claim 2, wherein
each ultraviolet irradiation member emits ultraviolet rays whose wavelength is in a range from 200 nm to 300 nm.

16. The ultraviolet irradiation apparatus of claim 3, wherein
each ultraviolet irradiation member emits ultraviolet rays whose wavelength is in a range from 200 nm to 300 nm.

17. The ultraviolet irradiation apparatus of claim 4, wherein
each ultraviolet irradiation member emits ultraviolet rays whose wavelength is in a range from 200 nm to 300 nm.

18. The ultraviolet irradiation apparatus of claim 5, wherein
each ultraviolet irradiation member emits ultraviolet rays whose wavelength is in a range from 200 nm to 300 nm.

19. The ultraviolet irradiation apparatus of claim 6, wherein
each ultraviolet irradiation member emits ultraviolet rays whose wavelength is in a range from 200 nm to 300 nm.
